(19) United States
(12) Patent Application Publication
(10) Pub. No.: US 2022/0234889 A1
(43) Pub. Date: Jul. 28, 2022

(54) METHOD TO CONTROL SYNGAS COMPOSITION BY REACTOR TEMPERATURE

(71) Applicants: Bradley D. Damstedt, Williamsville, NY (US); Lawrence E. Bool, East Aurora, NY (US)

(72) Inventors: Bradley D. Damstedt, Williamsville, NY (US); Lawrence E. Bool, East Aurora, NY (US)

(21) Appl. No.: 17/543,918

(22) Filed: Dec. 7, 2021

Related U.S. Application Data
(60) Provisional application No. 63/141,049, filed on Jan. 25, 2021.

(51) Int. Cl. C01B 3/36; C01B 3/48; C10J 3/72

(52) U.S. Cl. CPC C01B 3/36; C01B 3/48; C01B 2203/0255; C01B 2203/1241; C10J 2300/0916; C01B 2203/0283; C01B 2203/148; C10J 2300/1656; C10J 3/72

(57) ABSTRACT

Disclosed is methodology for controlling the H2:CO ratio of the product produced in a partial oxidation reactor, by carrying out the partial oxidation under temperature conditions that produce less than maximum conversion.

### RELATED APPLICATIONS

This application claims the benefit of U.S. Provisional Application Ser. No. 63/141,049, filed on Jan. 25, 2021, which is incorporated herein by reference.

### FIELD OF THE INVENTION

The present invention relates to the production of syngas so as to control significant characteristics of the syngas so produced.

### BACKGROUND OF THE INVENTION

Primary gasification is often used in industry to convert a feedstock to a syngas stream containing CO and/or H₂ by partial oxidation. A primary gasifier consists of a vessel, typically refractory lined, where a primary feed is mixed with an oxidant stream. Common oxidant streams include steam, CO2, oxygen, or mixtures of these streams. Depending on the source of the oxidant other species may also be included, such as N2 or Ar. The ratio of oxidant to feedstock is controlled such that less oxidant is provided than required to completely combust the feedstock. This condition, termed “fuel rich”, leads to the production of desired species such as CO and H2 by partial oxidation. The resulting crude syngas is typically then purified and sent to a downstream process for use. Examples of downstream processes include ethanol production and Fischer-Tropsch (“FT”) processes for liquid fuels production.

In some cases the syngas produced by primary gasification may contain significant amounts of unreacted higher molecular weight hydrocarbons which can be problematic for downstream equipment. One example of problematic hydrocarbons is those commonly denoted as “tars” that condense in downstream equipment potentially causing operational and efficiency issues. These problematic hydrocarbons can be further processed by secondary gasification of the hydrocarbon-containing syngas from a primary gasifier. This configuration is similar to a primary gasifier except that the feedstock to the secondary gasifier includes, at least in part, the crude syngas from the primary gasifier. A secondary gasifier may be used with feedstocks generated from hydrocarbon processing, such as refinery off gas (that is, crude syngas is not necessarily generated from a gasification process).

A gasification process is particularly suited for chemicals manufacturing. H2 and CO are converted to chemicals using a variety of processes, including catalytic or biological reactors. To optimize the efficiency of the chemical generating reactors, syngas from a gasification system is conditioned in any of several ways; a partial list of potential conditioning actions is given below. Each conditioning step increases the operating complexity as well as capital and operating cost of the overall chemical plant, so plants limit the number of conditioning steps to only those required.
remove catalyst poisons, for example HCN, sulfur containing species such as H2S or other contaminants
reduce diluents, for example CO2 and H2O
adjust properties, for example pressure and temperature
adjust chemical composition, for example adding nutrients for biological reactors or
adjusting the H2 to CO ratio using a water gas shift reactor (WGS).

Depending on the chemical being produced, different syngas properties are required to maximize efficiency. For example, production of transportation fuels using a Fischer-Tropsch system is most efficient with feeds having H2:CO ratios in the range of 1.95 to 2.05. The native H2:CO ratio of a gasification system may not fall within the range required by the downstream process. For example, the native H2:CO ratio of products formed by partial oxidation (POx) gasifiers using natural gas (“NG”) as a feedstock fall within the range of 1.7 to 1.8. If NG is being converted to syngas using a POx gasifier and the syngas is intended to be used to generate ethanol using FT processing, the H2:CO ratio of this syngas will preliminarily be adjusted upward using a WGS reactor. Because of the many types of gasifiers, feedstocks, chemical conversion processes and chemicals, it is recognized that linking the gasification process to the chemical product generation process will usually require adjustment of the H2:CO ratio.

Adjusting the H2:CO ratio in syngas produced by POx and other gasifiers has previously been accomplished by adding, directly into the POx reactor or into a reactant stream that is fed into the POx reactor, either H2O in the form of steam for situations where a higher H2:CO ratio is desired or a CO2 rich stream when a reduction in H2:CO ratio is desired. (For example, a source of CO2 may be a CO2 stream obtained by a removal process in the conditioning steps.) This is done primarily in steam methane reformers (SMR) but is also applied to a lesser extent with auto thermal reformers (ATR) or even to a lesser extent with partial oxidation reformers.

The present invention utilizes discoveries that enable the control of the characteristics of the syngas which is produced in the POx reactor, that provide advantages in being able to control the characteristics of the syngas and the operation of the plant.

### BRIEF SUMMARY OF THE INVENTION

One embodiment of the present invention is a method of producing syngas, comprising: feeding hydrocarbonaceous feedstock material and oxygen to a reactor;

partially oxidizing the hydrocarbonaceous feedstock material in the reactor to produce a product stream comprising H2, CO, and hydrocarbons that leaves the reactor, wherein the partial oxidation is carried out at reaction conditions including a reaction temperature which is lower than the temperature at which partial oxidation of the feedstock material, at the same reaction conditions other than the temperature, would minimize the amount of unreacted hydrocarbons in the product stream produced by partially oxidizing the feedstock material, thereby providing H2 and CO in the product stream wherein the H2:CO ratio is higher than the value the ratio would exhibit upon partial oxidation at said reaction conditions including at a temperature higher than said reaction temperature; and
recovering from the reactor a product stream comprising hydrogen and CO formed in the reactor and unreacted hydrocarbons.

In a preferred embodiment of this invention, unreacted hydrocarbon in said product stream, or products obtained by reaction of said unreacted hydrocarbon recovered from the product stream, is recycled to the reactor in which the partial oxidation is performed. This embodiment enhances the ability of the operator to improve overall efficiency of the plant based on the hydrocarbonaceous feedstock.

### BRIEF DESCRIPTION OF THE FIGURES

FIG. 1 is a flowsheet of a facility that utilizes partial oxidation to produce hydrocarbon product such as fuels from feedstock.

FIG. 2 is a cross-sectional view of a device that can produce a stream of hot oxygen useful in this invention.

FIGS. 3 through 8 are graphs showing characteristics of the invention.

### DETAILED DESCRIPTION OF THE INVENTION

The present invention is particularly useful in operations that convert hydrocarbon products such as biomass to useful hydrocarbon products such as (but not limited to) liquid fuel. The product produced by the present invention includes products that can be sold and used as-is, as well as products that can be used as reactants to produce other finished useful products that can then be sold and used.

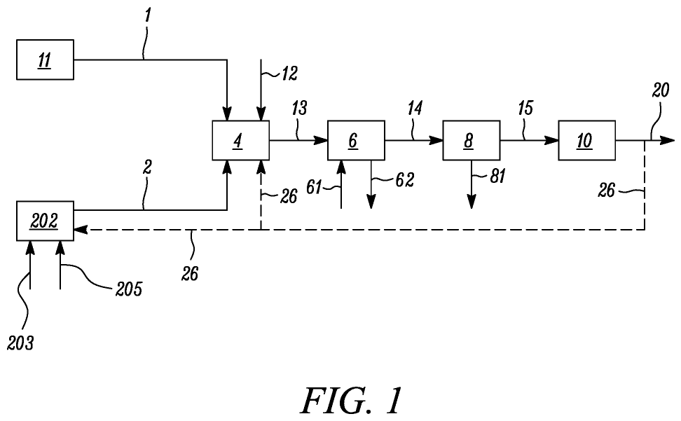

FIG. 1 is a flowsheet that shows the typical steps of such an operation.

Referring to FIG. 1, stream 1 which is also referred to herein as the raw feedstock is fed to partial oxidation reactor 4. Stream 1 is provided from source 11 which designates a production facility or reactor in which raw feed 1 is produced.

Examples of suitable raw feedstocks 1 and their sources 11 include:

Natural gas, from any commercial source thereof;

the gaseous stream that is produced by a gasification reactor, in which solid hydrocarbon material such as biomass or solid fossil fuel such as coal or lignin is gasified in a stream of gas usually comprising air, steam, and/or oxygen at a high enough temperature that at least a portion of the solid material is converted to a gaseous raw stream 1;

product streams and byproduct streams, which more often are gaseous but may be liquid and/or solids, that are produced in a petrochemical refinery or chemical plant;

coke oven gas, being the offgas stream that is produced in a reactor that heat treats coal to produce coke;

pyrolysis gas, being a hydrocarbon-containing gaseous stream that is produced in a reactor to heat treat solid carbonaceous material such as fossil fuel or biomass to devolatilize and partially oxidize the solid material;

Other possible feedstock streams include oils, such as pyrolysis oils, and liquid hydrocarbons.

Raw feedstock 1 generally contains hydrogen and carbon monoxide (CO), and typically also contains one or more hydrocarbons such as alkanes and/or alkanols of 1 to 18 carbon atoms, and often contains one or more of carbon dioxide (CO₂), and higher molecular weight hydrocarbons characterized as tars and/or soot.

The raw feedstock stream 1, if heated as it leaves source 11, typically exhibits a temperature of between about 500° F. and 1600° F.

Raw feedstock stream 1 is then fed into partial oxidation reactor 4 in which it is reacted (under conditions described more fully below) with oxygen that is provided as hot oxygen stream 2 (produced as more fully described below) to produce additional amounts of hydrogen and carbon monoxide (CO) from components present in stream 1. If tars are present in the stream, some or all of tars present can also be converted to lower molecular weight hydrocarbon products.

Steam, represented as stream 12, can optionally also be added to reactor 4, as described herein.

Oxidized product stream 13 which is produced in partial oxidation reactor 4 is fed to stage 6 in which stream 13 is preferably cooled and treated to remove substances that should not be present when the stream is fed to reactor 10 (described hereinbelow). Stage 6 typically includes a unit which cools stream 13, for instance by indirect heat exchange with incoming feed water 61 to produce stream 62 of heated water and/or steam. In alternative embodiments, stage 6 can also comprise a shift conversion reactor in which carbon monoxide in stream 13 is reacted (in a non-limiting example, with water vapor (steam)) in a catalytically mediated water-gas shift (“WGS”) reaction to produce hydrogen, thereby providing a way to adjust the ratio of hydrogen to carbon monoxide in stream 13. The heat removal in stage 6 and its beneficial advantages are described more fully below. The heat removal in stage 6 is performed before any other treatment or reaction of the syngas.

The resultant stream 14, having been cooled and/or having had its hydrogen:CO ratio adjusted in stage 6, is fed to stage 8 in which impurities 81 that may be present such as particulates, acid gases including CO₂, ammonia, sulfur species, and other inorganic substances such as alkali compounds, are removed. Impurities may be removed in one unit or in a series of units each intended to remove different ones of these impurities that are present or to reduce specific contaminants to the desired low levels. Stage 8 represents the impurities removal whether achieved by one unit or by more than one unit. Cooling and impurities removal are preferably performed in any effective sequence in a series of stages or all in one unit. Details are not shown but will be familiar to those skilled in the art. Stage 8 typically includes operations for final removal of impurities, non-limiting examples of which include particulates, NH₃, sulfur species and CO₂. The CO₂ removal is typically performed by a solvent-based process, which either uses a physical solvent, e.g. methanol, or a chemical solvent, e.g. amine.

The resulting cooled, conditioned gaseous stream 15 is then fed to stage 10 which represents any beneficial use of one or more components present in stream 15. That is, stream 15 can be used as-is as an end product. However, the present invention is particularly useful when stream 15 is to serve as feed material for further reaction and/or other processing that produces product designated as 20 in FIG. 1.

One preferred example of such further processing is conversion of stream 15 into liquid fuels, such as using stream 15 as feed material to a Fischer-Tropsch process or other synthetic methodology to produce a liquid hydrocarbon or a mixture of liquid hydrocarbons useful as fuel.

Other examples of useful treatment of stream 15 include the production of specific targeted chemical compounds such as ethanol, straight-chain or branched-chain or cyclic alkanes and alkanols containing 4 to 18 carbon atoms, aromatics, and mixtures thereof; or in the production of longer-chain products such as polymers.

The overall composition of stream 15 can vary widely depending on the composition of raw feedstock 1, on intermediate processing steps, and on operating conditions. Stream 15 typically contains (on a dry basis) 20 to 50 vol. % of hydrogen, and 10 to 45 vol. % of carbon monoxide.

However, it is preferred that one or more properties of stream 15 will continually exhibit a value, or a value that falls within a characteristic desired range, in order to accommodate the treatment that stream 15 is to undergo in stage 10 to produce a repeatable, reliable supply of product 20.

In a preferred practice of the present invention, the property of stream 15 that is relevant and that should be maintained within a desired ratio, is the molar ratio of hydrogen (H₂) to CO.

For FT fuels production, the target range of H₂:CO molar ratio depends on the product being produced. For example, ethanol production is most efficient with H₂:CO within the range of 1.95 to 2.05. Synthetic gasoline production requires a H₂:CO ratio in the range of 0.55 to 0.65. For fuels production by other conversion mechanisms, such as biological conversion, the target range of H₂:CO molar ratio can be very large. According to the Wood-Ljungdahl pathway, depending on the type of bacteria being used, streams containing only CO, only H₂ or any combination of H₂:CO can be utilized due to the bacteria's ability to convert H₂O and CO₂ into H₂ and CO as needed. Each bacterial strain will prefer a particular chemical makeup of syngas at which it is most efficient in producing the desired product.

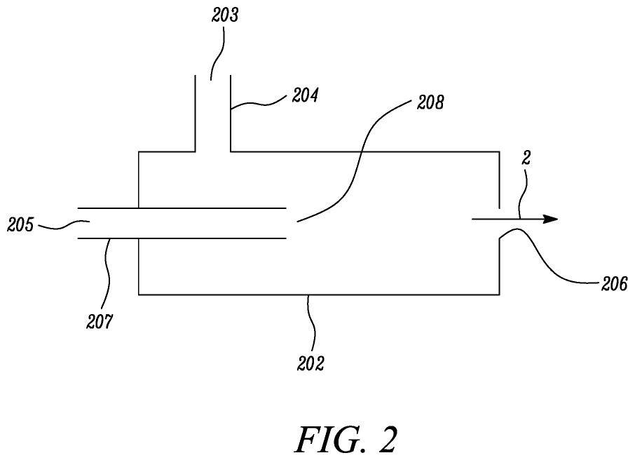

Referring again to FIG. 1, processing in stage 10 may produce byproduct stream 26, which can be recycled to partial oxidation reactor 4 to be used as a reactant, and/or recycled to hot oxygen generator 202 (described below with respect to FIG. 2) to be combusted in hot oxygen generator 202 as described herein. Steam (stream 62) formed from water stream 61 in stage 6 can be optionally fed to partial oxidation reactor 4.

Referring to FIGS. 1-2, hot oxygen stream 2 is fed to partial oxidation reactor 4 to provide oxygen for the desired partial oxidation of raw feedstock 1, and to provide enhanced mixing, accelerated oxidation kinetics, and accelerated kinetics of the reforming with reactor 4.

There are many ways in which the desired high temperature, high velocity oxygen-containing stream can be provided, such as plasma heating.

One preferred way is illustrated in FIG. 2, namely hot oxygen generator 202, that can provide hot oxygen stream 2 at a high velocity. Stream 203 of gaseous oxidant preferably having an oxygen concentration of at least 30 volume percent and more preferably at least 85 volume percent is fed into hot oxygen generator 202 which is preferably a chamber or duct having an inlet 204 for the oxidant 203 and having an outlet nozzle 206 for the stream 2 of hot oxygen. Most preferably the oxidant 203 is technically pure oxygen having an oxygen concentration of at least 99.5 volume percent. The oxidant 203 fed to the hot oxygen generator 202 has an initial velocity which is generally within the range of from 50 to 300 feet per second (fps) and typically will be less than 200 fps.

Stream 205 of fuel is provided into the hot oxygen generator 202 through a suitable fuel conduit 207 ending with nozzle 208 which may be any suitable nozzle generally used for fuel injection. The fuel may be any suitable combustible fluid examples of which include natural gas, methane, propane, hydrogen and coke oven gas, or may be a process stream such as stream 26 obtained from stage 10. Preferably the fuel 205 is a gaseous fuel. Liquid fuels such as number 2 fuel oil or byproduct stream 23 may also be used.

The fuel in stream 205 and the oxidant stream 203 should be fed into generator 202 at rates relative to each other such that the amount of oxygen in oxidant stream 203 constitutes a sufficient amount of oxygen for the intended use of the hot oxygen stream. The fuel 205 provided into the hot oxygen generator 202 combusts therein with oxygen from oxidant stream 203 to produce heat and combustion reaction products which may also include carbon monoxide.

The combustion within generator 202 generally raises the temperature of remaining oxygen within generator 202 by at least about 500° F., and preferably by at least about 1000° F. The hot oxygen obtained in this way is passed from the hot oxygen generator 202 as stream 2 into partial oxidation reactor 4 through and out of a suitable opening or nozzle 206 as a high velocity hot oxygen stream having a temperature of at least 2000° F. up to 4700° F. Generally the velocity of the hot oxygen stream 2 as it passes out of nozzle 206 will be within the range of from 500 to 4500 feet per second (fps), and will typically exceed the velocity of stream 203 by at least 300 fps. The momentums of the hot oxygen stream and of the feedstock, should be sufficiently high to achieve desired levels of mixing of the oxygen and the feed. The momentum flux ratio of the hot oxygen stream to the feedstock stream should be at least 3.0.

The composition of the hot oxygen stream depends on the conditions under which the stream is generated, but preferably it contains at least 50 vol. % O₂ and more preferably at least 65 vol. % O₂. The formation of the high velocity hot oxygen stream can be carried out in accordance with the description in U.S. Pat. No. 5,266,024.

It will be recognized that the desired state of systems that employ partial oxidation in the course of producing a desired hydrocarbon product stream is this: that there is little or no perturbation of the characteristics of the raw feedstock 1, of the oxygen stream 2, or of streams 13, 14 and 15, nor of the operating conditions employed in the partial oxidation reactor 4 and in stages 6 and 8. In addition, circumstances may arise in which characteristics of raw feedstock 1 to the POx reactor change in a way such that, if nothing else changes in the operating conditions, the characteristics of stream 13 or 15 would be changed in a manner that would adversely affect the characteristics of the desired product stream 20. Such a change in stream 20 is, of course, undesirable.

Alternatively, it will also be recognized that the characteristics of the product to be formed in stage 20 are required to change, necessitating a change on the H2:CO ratio of the syngas at 13.

The characteristics of raw feedstock 1 that could change include the total hydrocarbon concentration of the raw feed; the total concentration of C₂H₂, C₂H₄, and tars; and the temperature. Examples of circumstances that could cause any of these characteristics to change include:

The composition of raw feedstock 1 has changed because the feed to source 11 has changed.
The raw feedstock 1 from its source 11 has become too expensive relative to other compositions, from other sources, that could be useful feedstock material to the POx reactor 4.
The treatment provided in one or more of the stages 6 and 8 has changed, such as changes to the catalytic processing that is provided in the WGS reaction.
The injector system that feeds material into the POx reactor has been damaged or fouled so that the ability of the feedstock material to be entrained into the hot oxygen stream is lessened, thereby leading to excessive methane slip, excessive tar slip, and/or excessive soot formation.

In the past, customary practice to accommodate changes in circumstances such as these, which involve changes to characteristics of the raw feedstock 1 to POx reactor 4 or changes to the desired product of 20, has often been shutting down the overall facility, or at best running the facility at a partial load which is detrimental to capital recovery. When that occurs, an operator who has more than one such facility must then rely on the output of product that is available from other facilities, or else suffer the loss of production.

It has been found however that the present invention enables the operator several advantages: the ability to adjust the H2:CO ratio of the syngas product that emerges from the POx reactor, to compensate for any changes in the overall operation that would require adjustment of the H2:CO ratio of that product; and the ability to improve the overall efficiency of utilization of the feedstock material.

One advantage of this invention is the ability to affect the H2:CO ratio of the product stream 13. This is confirmed in Example 1.

### Example 1

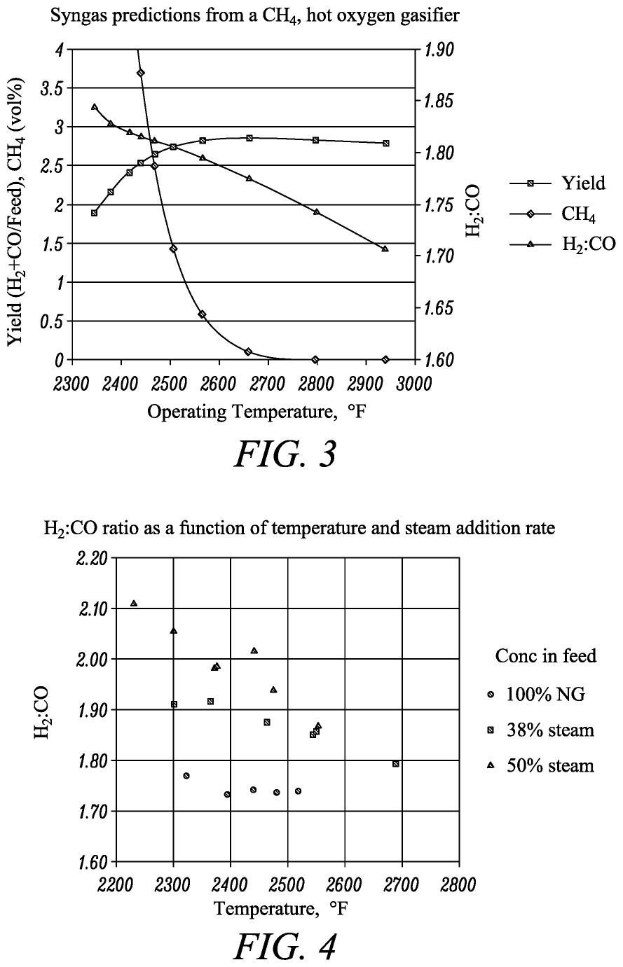

In Example 1, syngas generated by reacting ambient temperature CH4 with hot oxygen generated through the use of a thermal nozzle as described herein with reference to FIG. 2. The reactor pressure is assumed to be 115 psig and the reactor is assumed to be adiabatic. A previously validated kinetic model was used to estimate syngas production after 4 seconds residence time. Results from the prediction are shown in FIG. 3, plotted as a function of reactor temperature. Yield is given as the combined amount of (H2+CO) divided by the total amount of CH4 used, shown as the curve in squares. CH4 slip is shown as the curve in diamonds and the H2:CO ratio is shown as the curve in triangles.

In this example a starting point is assumed that produces an operating condition of 0.5% CH4 slip, which gives an operating temperature close to 2575° F. This represents the typical operating practice which seeks to maximize the yield of H2+CO while minimizing the gasifier temperature. To achieve a higher H2:CO ratio in the partially oxidized product stream, the operating temperature is decreased (by either reducing the amount of oxidant supplied or by increasing the amount of feedstock supplied). Reducing the reactor temperature from 2575° F. to 2400° F. increases the H2:CO ratio from 1.78 to 1.82. The impact to yield is a reduction from 2.82 to 2.3. This reduction in yield is a result of lower CH4 conversion, represented by an increase in CH4 slip from 0.5% to approximately 5%. The excess CH4 is likely separated downstream in the syngas conditioning steps and can be used either as a fuel source for unit operations requiring energy input or recycled back to the gasifier to offset feedstock requirements.

It is also possible to increase or maximize H2:CO ratio of the product 13 by both reducing reactor temperature and adding steam. This impact was investigated in a pilot scale experiment, using hot oxygen as the oxidant. Three feedstock variations were studied: 100% natural gas, a mixture of natural gas and steam with 38% steam, and a mixture of natural gas and steam with 50% steam. FIG. 4 shows the H2:CO ratio that results from these experiments. The results with 100% natural gas are shown as circles. The results with 38% steam present are shown as squares. The results with 50% steam present are shown as triangles. Examining each feedstock composition at a given operating temperature shows the typical effect of an increasing H2:CO ratio as steam in the feedstock increases. For example, choosing 2500° F. shows H2:CO increasing from 1.75 with 100% natural gas, to 1.86 and then 1.91 with steam at 38% and 50%. A similar trend as noted above for pure CH4 is also observed for each feedstock mixture in FIG. 4, with H2:CO ratio increasing as reactor temperature decreases. Of particular note is the observation that not only does the H2:CO ratio increase as reactor temperature is decreased, but the rate at which H2:CO increases is higher for feedstock mixtures containing steam. This is the case when comparing results with 100% natural gas to results with 38% steam concentration as well as comparing 38% steam concentration to 50% steam concentration.

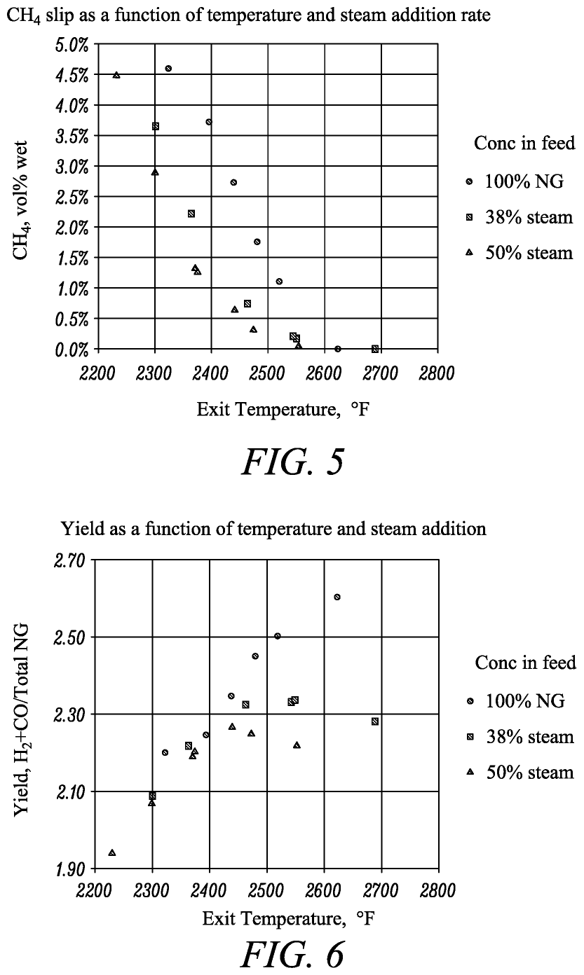

A further benefit of adding steam and reducing operating temperature is shown in FIGS. 5 and 6. CH4 slip measured during the experiments is shown in FIG. 5, showing that CH4 slip remains lower for a longer amount of temperature reduction with steam than with 100% natural gas. This is reflected further in FIG. 6, which shows the yield for the experiments. In FIGS. 5 and 6, the results with 100% natural gas are shown as circles, and the results with 38% steam present are shown as squares, and the results with 50% steam present are shown as triangles. While results with 100% natural gas provide the highest efficiency, a reduction in temperature does not cause the H2+CO yield to drop as rapidly if steam is included in the feedstock as for the case with 100% natural gas.

Current gasifiers, both primary and secondary, are designed and operated such that the reactor temperature is minimized to avoid limiting refractory life while still processing the syngas such that little or no residual hydrocarbon, called hydrocarbon slip, is left in the syngas. The optimal operating condition is therefore defined in prior practice as the condition that generates the highest amount of (CO and H2) and that reacts all the hydrocarbons. Practically speaking the reactor temperature has to be high enough to minimize hydrocarbon slip. However, the reactor temperature must be only as hot as required to achieve complete hydrocarbon conversion. Any additional heat release above this point comes from burning the product gas and should, therefore, be avoided. For example, if the hydrocarbon slip limit is defined as 0.5% of hydrocarbon in the syngas, the reactor temperature will be held to a value that ensures the hydrocarbon slip never exceeds the desired value but no higher. Any unreacted hydrocarbon leaving the gasifier is removed during downstream processing and either purged and sent to a flare, or is used in a lower value method (fuel value).

By contrast, in the present invention described herein, the gasifier, whether primary or secondary, is operated counter to conventional wisdom such that the hydrocarbon slip is increased. In this case the gasifier is operated at a lower temperature, which would yield a lower single pass efficiency. However, by operating at a lower temperature less of the hydrocarbon that is consumed ends up as complete combustion products (CO₂ and H2O). This means the amount of CO and H2 produced per unit of hydrocarbon consumed is increased. If the unreacted hydrocarbons are recycled to the gasifier after separation from the syngas (or from products derived from the syngas) the overall hydrocarbon yield can be increased per amount of fresh feed.

This invention is particularly valuable if the carbon and hydrogen atoms in the feedstock have value above simple fuel value. For example, if the carbon and hydrogen atoms in the feedstock are from renewable sources, then the final products derived from these renewable sources, such as a transportation fuel, may have a much higher value than if those same carbon and hydrogen molecules are simply flared or used as a fuel. Similarly if the hydrocarbon feedstock is more expensive than a conventional feedstock it is desirable to convert more of the hydrocarbon feedstock to final product.

### Example 2

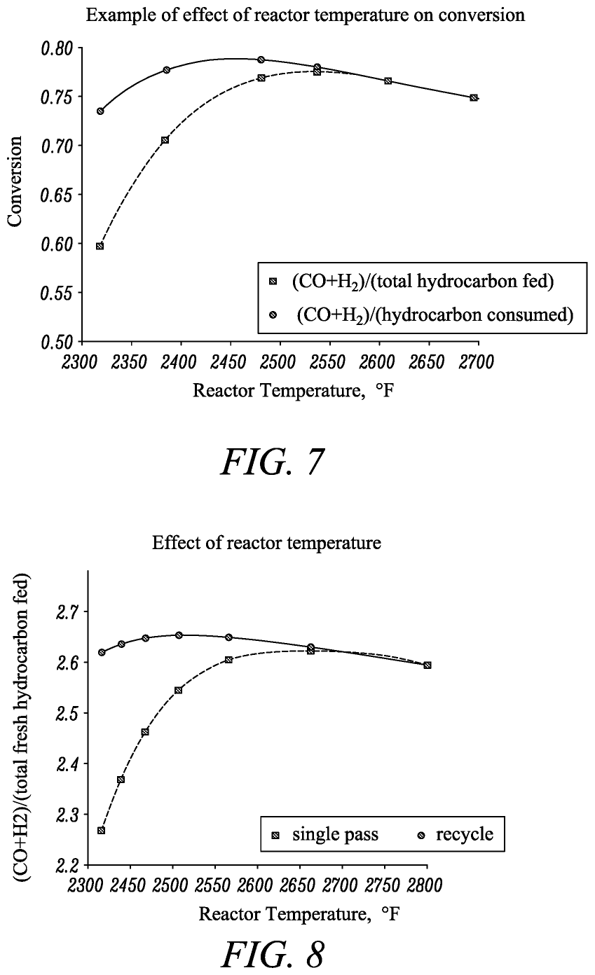

In this example, a crude syngas generated from an upstream hydrocarbon processing unit is reacted in a secondary gasifier. The oxidant is hot oxygen generated through the use of a thermal nozzle as described herein with reference to FIG. 2. Compositions for the crude feedstock, fuel to the thermal nozzle, and oxygen to the thermal nozzle are shown in Table 1. In this example none of the supplies are assumed to be preheated (i.e.; feedstock to the gasifier, fuel and oxygen to the thermal nozzle, are all assumed to be at ambient temperature). The reactor pressure is assumed to be 50 psig and the reactor is assumed to be adiabatic. A previously validated kinetic model was used to estimate the syngas production after 4 seconds residence time. As can be seen from FIG. 7, the peak bulk conversion efficiency takes place at a reactor temperature of approximately 2530° F. However, operating at a lower temperature of approximately 2450° F. yields an increase in the hydrocarbon conversion efficiency of approximately 1%.

TABLE 1
Flow stream composition (volume %)

| | Feed | Fuel | Oxygen |
|---|---|---|---|
| H2 | 25.00% | | |
| O2 | | | 100.00% |
| H2O | 25.00% | | |
| CH4 | 15.00% | 92.00% | |
| CO | 15.00% | | |
| CO2 | 15.00% | 2.00% | |
| C2H4 | 2.50% | | |
| C2H6 | | 3.00% | |
| C3H8 | 2.50% | | |

### Example 3

In this example pure ambient temperature methane is fed to a primary gasifier where it is mixed with the effluent of a thermal nozzle that produced hot oxygen from a mixture of ambient temperature pure methane and ambient temperature pure oxygen. The gasifier is assumed to be adiabatic and operate at 115 psig. The validated kinetic model was used to estimate the syngas characteristics from the reactor at 4 seconds residence time. The results of the kinetic calculations are shown in FIG. 8. When the gasifier is operated in single pass mode, consistent with normal gasifier operation, the peak conversion of the total fresh methane fed to the reactor (feed and thermal nozzle fuel) is found at approximately 2660° F. If the gasifier stoichiometric ratio is reduced such that the temperature is approximately 2510° F. then the single pass conversion is dramatically reduced and less product CO and H2 is produced per mole of fresh methane fed (feed and thermal nozzle fuel). However, if the residual methane is separated and recycled to the gasifier the conversion production of CO and H2 is increase significantly per mole of fresh methane fed (feedstock and thermal nozzle fuel). This means more of the original carbon and hydrogen atoms will end up and the desired final product.

What is claimed is:

1. A method of producing syngas, comprising:
feeding hydrocarbonaceous feedstock material and oxygen to a reactor;
partially oxidizing the hydrocarbonaceous feedstock material in the reactor to produce a product stream comprising H2, CO, and hydrocarbons that leaves the reactor, wherein the partial oxidation is carried out at reaction conditions including a reaction temperature which is lower than the temperature at which partial oxidation of the feedstock material, at the same reaction conditions other than the temperature, would minimize the amount of unreacted hydrocarbons in the product stream produced by partially oxidizing the feedstock material, thereby providing H2 and CO in the product stream wherein the H2:CO ratio is higher than the value the ratio would exhibit upon partial oxidation at said reaction conditions including at a temperature higher than said reaction temperature; and
recovering from the reactor a product stream comprising hydrogen and CO formed in the reactor and unreacted hydrocarbons.

2. A method according to claim 1 wherein unreacted hydrocarbon in said product stream, or products obtained by reaction of said unreacted hydrocarbon recovered from the product stream, is recycled to the reactor in which the partial oxidation is performed.

3. A method according to claim 1 wherein the hydrocarbonaceous feedstock material comprises natural gas.

4. A method according to claim 1 wherein the hydrocarbonaceous feedstock material comprises biomass.

5. A method according to claim 1 wherein the hydrocarbonaceous feedstock material is derived from fossil fuel.

6. A method according to claim 1 wherein the partial oxidation is carried out with a gaseous stream comprising at least 50 vol. % oxygen.

7. A method according to claim 1 wherein the partial oxidation is carried out by feeding oxygen into the reactor at a velocity of 500 to 4500 feet per second.

8. A method according to claim 1 wherein the partial oxidation is carried out by feeding oxygen into the reactor at a temperature of at least 2000° F.

9. A method according to claim 1 wherein the H2:CO ratio in the product stream is at least 1.75

10. A method according to claim 1 wherein the H2:CO ratio in the product stream is 1.95 to 2.05

11. A method according to claim 1 wherein the H2:CO ratio in the product stream is 0.55 to 0.65.

12. A method according to claim 1 further comprising adding steam to the reactor.
